(19) United States
(12) Patent Application Publication
(10) Pub. No.: US 2021/0387035 A1
(43) Pub. Date: Dec. 16, 2021

(54) POLE WITH ILLUMINATION ELEMENTS

(71) Applicant: KEVIN PATEL, TAMPA, FL (US)

(72) Inventor: KEVIN PATEL, TAMPA, FL (US)

(21) Appl. No.: 17/285,273

(22) PCT Filed: Oct. 16, 2019
(86) PCT No.: PCT/US19/56610

§ 371 Date: Apr. 14, 2021

Related U.S. Application Data
(60) Provisional application No. 62/746,387, filed on Nov. 5, 2018.

(51) Int. Cl. A63B 9/00; F21V 8/00; F21V 23/04; F21S 9/02; F21V 29/70

(52) U.S. Cl. CPC A63B 9/00; G02B 6/0008; F21Y 2115/10; F21S 9/02; F21V 29/70; F21V 23/0435

(57) ABSTRACT

A safety dance pole with a light display includes an opaque tube member with an programmable light display member configured for placement inside of the opaque tube member. A plurality of circumferentially arranged apertures extending through an outer surface of the tube member to a cavity within include light pipes configured to transmit light from the light display member past the outer surface of the opaque tube member. The dance pole includes a programmable controller which may be operated by wired or wireless means. The dance pole may be rotatable or suspendable. The light controller and light display may be powered by household current or one or more batteries.

### CROSS-REFERENCE TO RELATED APPLICATIONS

This application claims the benefit of U.S. Provisional Patent Application No. 62/746,387 with a filing date of Oct. 16, 2018 and entitled “Pole with Illumination Elements.”

### TECHNICAL BACKGROUND

This disclosure relates generally to exercise equipment and more specifically to dance poles.

### BACKGROUND

Dance poles used for exercise and entertainment purposes are known in the art. Recently, lighted dance poles have been made available and typically include a rigid core with LED and/or fiber optic elements surrounded by a translucent sleeve such that the pole generated light display is visible. The translucent sleeve may be acrylic or other clear plastic. While the plastic encased poles work reasonably well for their intended use, concerns regarding the durability and safety of the plastic poles have arisen, due in part to the stresses being placed on the poles by increasing athleticism of dancers. In the past, dance poles have failed catastrophically causing injury. Whereas metal is prone to bending when subjected to stresses beyond a certain threshold, plastic is apt to shatter or form stress cracks “crazing,” raising the possibility of serious injury such as laceration. What is needed is a lighted pole that is durable, possesses superior rigidity for the most athletic of dancers and one configured to bend—but not shatter in the unlikely case of a structural failure.

### SUMMARY

In one general example implementation, a dance pole includes a generally cylindrical opaque tube member surrounding a lighting display member or lighting support, the opaque tube member includes a wall thickness between and 3 mm and 13 mm, and the opaque tube member includes a circumferential arrangement of light pipes. The light pipes include a translucent material extending from one or more internal cavities of the opaque tube to the exterior surface of the opaque tube member and are flush therewith forming a smooth gapless cylindrical surface. One or more light display members is disposed in the one or more internal cavities of the opaque tube member. Opaque regions (116) between the light pipes do not conflict with or affect characteristics of light; e.g., intensity, diffusion, color, emitted by the light pipes and is able to display non-diffused light shapes and patterns. Certain implementations may be suitable for safety handrails and beacons as the light pipe display is capable of directional movement which may be helpful in guiding persons in power outages and crisis situations.

In a first aspect combinable with the general implementation, the opaque tube member may include a wall thickness of between 3 and 13 mm.

A second aspect combinable with any of the previous aspects, the opaque tube member may be a metal such as high grade aluminum, stainless steel, chrome plated steel or a ceramic such as silicon nitride.

In a third aspect combinable with any of the previous aspects, the opaque tube member may have a minimum tensile strength of 300 Mpa.

In a fourth aspect combinable with any of the previous aspects, the opaque tube member may have a diameter between 38 mm and 78 mm.

In a fifth aspect combinable with any of the previous aspects, the one or more lighting display members can include one or more LEDs interfaced with a programmable light display controller with a wireless; e.g., WiFi or Bluetooth, transceiver module.

In a sixth aspect combinable with any of the previous aspects, a programmable controller configured to control patterns of light display may be managed remotely via a user interface on a computing device.

In a seventh aspect combinable with any of the previous aspects, light pipe media may be tinted or include colored filters applied thereto.

In an eighth aspect combinable with any of the previous aspects, the one or more cavities of the opaque tube member may include a filler material; e.g., water clear resin, fiber filled resin, inside the one or more cavities which may encapsulate the one or more light display members. Further, in some implementations, the resin may be adapted to extend through apertures in the tube member forming light pipes.

In a ninth aspect combinable with any of the previous aspects, suitable powering of the light display controller and the one or more light display members may include household current modified by power supply/voltage converter or power may be supplied by batteries.

In a tenth aspect combinable with any of the previous aspects, the opaque tube member may be mounted to a surface such as a platform, and may be axially rotatable relative to the platform.

In a eleventh aspect combinable with any of the previous aspects, the opaque tube member may be configured to extend from a first position to a relatively elongated position.

In a twelfth aspect combinable with any of the previous aspects, the opaque tube member may be suspended from a top end.

In a thirteenth aspect combinable with any of the previous aspects, light display characteristics; e.g., intensity, tempo, color, etc., may be readily altered by a remote user interface running on a mobile computing device; e.g., smart phone.

In a fourteenth aspect combinable with any of the previous aspects, the one or more light display members may include fiberoptic elements.

In a fifteenth aspect combinable with any of the previous aspects, the light display controller may include a sound detector module with analog and digital output so as to program the light display components to respond to live or recorded music.

In a sixteenth aspect combinable with any of the previous aspects, any of the dance pole components may be battery powered.

These general and specific aspects may be implemented using a device, system or method, or any combinations of devices, systems, or methods. The details of one or more implementations are set forth in the accompanying drawings and the description. Other features, objects, and advantages will be apparent from the description and drawings, and from the claims.

### DESCRIPTION OF DRAWINGS

FIG. 1 illustrates a side elevation of an example implementation of a dance pole according to the present invention;

FIG. 2 is an orthographic view of the implementation shown in (FIG. 1);

FIG. 3 is an enlarged detail view of call-out (3) shown in (FIG. 1);

FIG. 4 is an enlarged detail view of call-out (4) shown in (FIG. 2);

FIG. 5 is a cross sectional view taken along lines 5-5 shown in (FIG. 3);

FIGS. 6A-6D are example cross-sectional views of various implementations of a dance pole according to the present invention;

FIG. 7 is a partial cut-away view showing the interior of an example implementation;

FIGS. 8A-8D are partial views illustrating various light pipe patterns;

FIG. 9 shows a partial side elevation of an example implementation including a topper;

FIG. 10 shows a partial side elevation of an example anchoring assembly suitable for various implementations;

FIG. 11 is another partial side elevation of an example implementation including a topper;

FIG. 12 is another partial side elevation of an example anchoring assembly suitable for various implementations;

FIG. 13 illustrates a typical suspension member that may be used with various implementations according to the present invention.

### REFERENCE LISTING OF THE NUMBERED ELEMENTS

100 dance pole apparatus
102 opaque tube
104 tube wall
105 outer surface
106 tube cavity
108 aperture/opening
110 light transmissible media
112 light tube/pipe
114 light tube pattern
116 opaque region
120 light display member/support
121 light display support void
122 LED
123 LED strip
124 light source
126 filler/pot material
128 positioning element
130 slip ring
133 controller
134 wireless/Wifi module
135 WiFi antenna
136 power supply
137 battery
138 topper
140 user interface
141 sound detector module
144 inductive powering/charging
150 bearing assembly
151 platform/mounting surface
152 stabilizing member
154 suspension assembly
156 swivel coupling
158 carabiner

### DETAILED DESCRIPTION

The figures and following description illustrate and explain a safety dance pole apparatus for exercise and entertainment purposes. In the detailed description that follows, the singular terms “a”, “an”, and “the” include plural referents unless the context clearly indicates otherwise. Similarly, the word “or” is intended to include “and” unless the context clearly indicates otherwise. Although methods and materials similar or equivalent to those described herein can be used in the practice or testing of this disclosure, suitable methods and materials are described below. It should be understood that the objects, features and aspects of any implementation/embodiment disclosed herein may be combined with any object, feature or aspect of any other implementation/embodiment without departing from the scope of the invention. The term “comprises” means “includes.” All publications, patent applications, patents, and other references mentioned herein are incorporated by reference in their entirety for all purposes. In case of conflict, the present specification, including explanations of terms, will control. In addition, the materials, methods, and examples are illustrative only and not intended to be limiting.

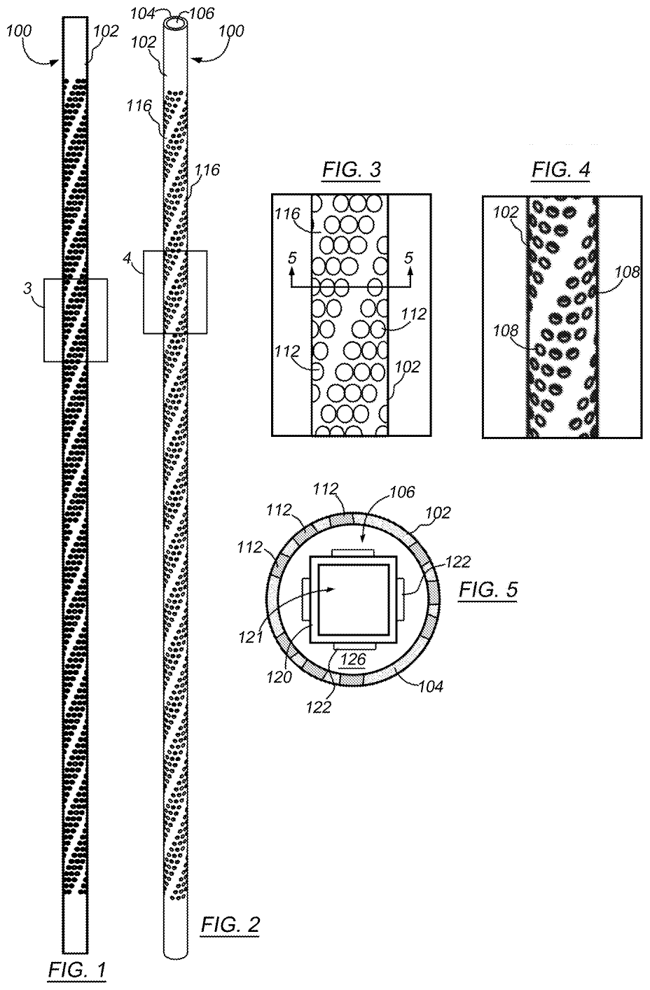

Generally referring to FIGS. 1-13, an example implementation of a dance pole apparatus (100) includes an opaque tube member (102) with at least one cavity (106) therein. In some implementations, the opaque tube member is a length of metal or ceramic tube with a single longitudinal cylindrical bore. In other implementations, the the opaque tube member (102) may have more than one longitudinal bore/channel/cavity (106). The one or more cavities of the opaque tube member (102) form a housing for a light display support (120) which may be an insertable component on which individual LEDs (122) or a LED strips (123) are mounted. Typically, the light display support (120) may have one or more cavities (121) suitable for the placement of wiring, controllers, etc. Persons having skill in the art and access to this disclosure will appreciate that the LEDs (122) may be mounted to alternative surfaces within the tube cavity (106). It is conceivable that instead of the linear arrangement common with LED strips (123), LEDs (122) may be mounted in non-linear; e.g., staggered, patterns directly to an insertable component. Insertability of the support (120) provides for removal, replacement, respositioning and servicing. It is possible that fiberoptic elements may be combined with LEDs (122). Pole tube diameter may range anywhere from 38 mm and 78 mm, with common sizes of 40 mm, 45 mm and 50 mm. Pole length may vary as needs require, but is typically from 2.5 meters to 7.5 meters. Irrespective of pole length, the principles of operation described herein apply. Manufacture of some implementations includes machining a circumferential pattern of apertures (108) that extend from the outer surface (105) of the opaque tube member (102) to the one or more internal cavities (106) such that light generated by the LEDs (122) is viewable through the apertures. Apertures (108) are then filled with clear or tinted resin or acrylic rod segments; e.g., Lucite® rods, that are inserted into the apertures, forming light pipe type construction. In either case, the light transmissible media (110) of the light pipes (112) are formed flush or machined flush with the outer surface (105) of the opaque tube (106) which produces a continuously smooth and gapless cylindrical surface. Light pipes (112) may be arranged circumferentially about the opaque tube (102) in any pattern that may include spirals of varying twist, helices, circles, short straight lengths etc. LEDs (122) are interfaced with a programmable controller (133) that may store and playback different lighting display sequences. In some implementations, it is possible to stream lighting display sequences to the controller. The programmable controller (133) is typically managed by a user interface (140), which may be a web application running on a smart phone or laptop. Programmable controller (133) is also capable of dynamically generating lighting displays in response to sound stimulus; e.g. live or recorded music, fireworks, etc. In some implementations, the dance pole may be rotatable, in which case the dance pole (100) may include a self contained power supply such as a battery (137) or in cases where the dance pole is mounted to a raised platform (151), powering connectors may be interfaced with a slip ring (130). In some implementations, a battery powering the controller (133) and lights may be charged by an inductive charger (144) mounted in the platform. In some implementations, the dance pole includes a topper (138) that may be a disco ball themed component with light pipe (112) construction similar to opaque tube (102). In other cases, the topper includes unfilled apertures. It is conceivable that the topper include an internal cavity capable of housing a WiFi antenna (135), a battery (137) or light display controller (133). In some cases, the topper (138) may produce a light display independent of the lower portions of the dance pole. In some cases, the light display(s) of the dance pole and topper are synchronized. In some implementations, the outer surface (105) of the opaque tube (102) excepting the light pipes (112) may include a coating of Vantablack® or another extreme light absorbing material such as Super Black or Black 3.0, such that light emitted from the light tubes may appear as isolated non-diffuse discs of light without a supporting structure.

Materials and Methods

Persons having skill in the art and access to this disclosure will appreciate alternative controllers, drivers, LEDs, and sound detection modules of various manufacture suitable for use in the various disclosed implementations. In one example implementation, a dance pole approximately 250 cm in length has a central tubular body that includes a spiraled arrangement of apertures that include light pipe (112) elements extending from a outer surface (105) of the tubular body (102) to a longitudinal cavity (106). Housed in the cavity are a plurality of LED strips (123); e.g., WS2813 5050smd 60 LEDs/m, that are mounted to a polygonal or cylindrical support (120) that resides lengthwise in the cavity. In various implementations, a 5 VDC power supply is typically used for LED strips from 0-10 m in length, 12 VDC is used for 0-30 m in length and 24 VDC is used for >30 m in length. Power conversion from AC to DC may be provided by a Mean Well LPV-100 series that includes options for 5V, 12V and 24V power supply. Voltage to LED strips is regulated by a buck—boost transformer. For power continuity in rotatable implementations, a WYPH 250 Rpm 3 Wires Mini Slip Ring 15A 240V may be used. For implementations employing a battery (137) power supply, a 200 W Wurth Electronic Qi Wireless Power Charging Coil system (144) may be used to charge the battery. Suitable LED strip controllers include the Pixelblaze WiFi LED Controller (133) that may be coupled with a sound sensor board/module (141) to produce sound responsive light displays, or an Arduino board also coupled with a sound sensor board and using the FastLED library which includes open source LED drivers.

Moving to FIGS. 1 and 2, while the circumferential arrangement of the light pipes (112) shown with triple spiral groupings, the non-limiting example patterns may be a single or double spiral, single spirals interspersed with double spiral groupings or single, double or triple spirals interspersed with randomly arranged light pipes. Alternately, the light pipes (112) may be arranged in stacked concentric rings, short length diagonal or longitudinal groups or any other attractive configuration. Apertures (108) encircling the light pipe (112) construction need not be cylindrical voids, and may be any shape that will accommodate a light transmissible material (110). For example, apertures (108) may be drilled with a normal cylindrical bit, and an insert having a non-cylindrical cut out; e.g., stars, letters, or other shapes, pressed into the resulting aperture prior to the insertion of the acrylic rod segment or application of translucent resin. It should be understood that pole (100) may include a unitary section of opaque tube (102) or it may be disassembled in two or more tubes for transport. Apertures may be configured radially about the tube (102) such that the axis of the aperture is perpendicular to the outer surface (105) of the tube. In some cases, aperture axes may greater or less than 90° with respect to the outer surface.

FIGS. 3 and 4 are respectively, an enlarged detail view of call-out (3) shown in (FIG. 1), and, an enlarged detail view of call-out (4) shown in (FIG. 2).

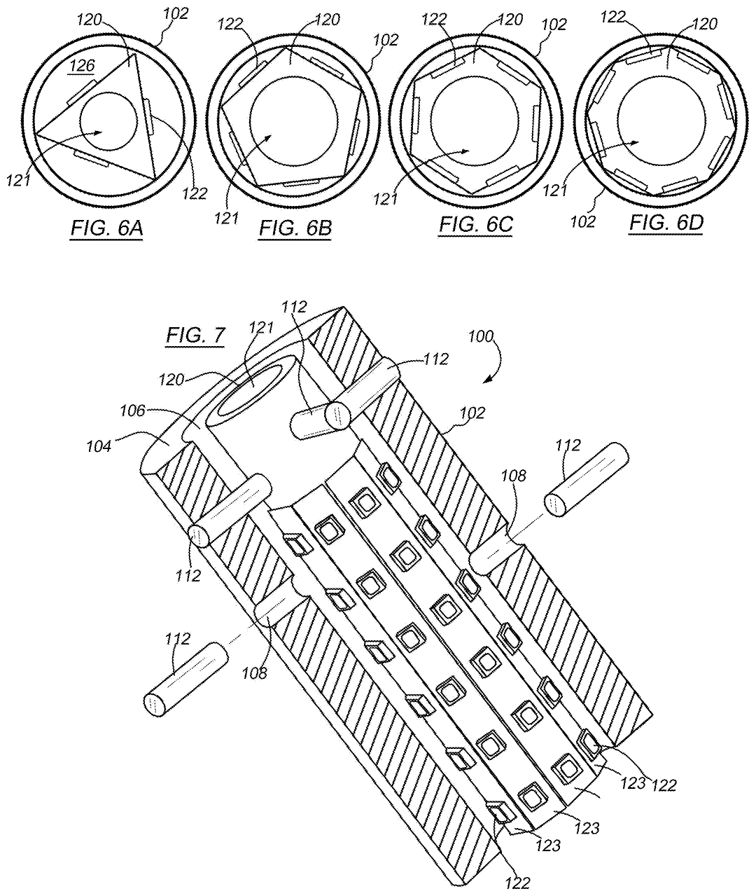

FIG. 5 is a cross-sectional view taken respectively along lines 5-5 of (FIG. 2). Typically, the body of pole (100) includes opaque tube (102) which provides rigidity to the construction and possesses a tensile strength of at least 300 Mpa. The opaque tube (102) may be one of several opaque materials such as 6061 T6 Al, 7175 TAI, SAE 316L stainless steel, chrome plated steel, titanium and select ceramics such as silicon nitride. Wall (104) thickness may be anywhere from 3 mm-13 mm depending on the material. As used herein, the term “wall” refers to one or more peripheral structures beyond cavity (106). Apertures (108) that extend from the outer surface (105) of the opaque tube (102) to inner cavity (106) are filled with a acrylic rod or a suitably light transmissible media (110) such as a non-yellowing water clear castable acrylic resin or urethane. In cases where castable resins are used, an removable cover may be over the outer surface (105) in order to block fluid resin while cavity (106) is filled with resin such that any voids around the light display support (120) and the outer wall (105) are filled with resin. Tube (102) may be subjected to a vacuum during the resin filling to avoid air entrapment in the resin plugs. Once the resin is cured, the covering is removed and the resin plugs sanded, turned down or ground down to match the curvature of the outer surface of the tube. In some implementations, filling internal cavities with resin may increase the tensile strength of the pole. In other implementations, segments of acrylic rod are glued or friction fitted in the machined apertures (108) and non-flush segments are sanded, turned down or ground down to match the curvature of the outer surface (105). In either case, polishing compounds may be applied to the opaque tube and the light pipes to polish the entire outer surface (105) to a high luster.

FIGS. 6A-6D are non-limiting example cross-sectional views of various implementations according to the present invention. As shown, the light display member or support (120), may be any shape and size suitable for insertion into opaque tube cavity (106). Some implementations employing an abundance of LEDs (122) and correspondingly higher voltages; e.g., 24 VDC, may include air ducting channels adjacent any light emitting components. In some implementations, a heat pipe may run longitudinally inside the opaque tube. In some implementations the foregoing heat pipe may terminate in a heat sink assembly placed in a pole topper (FIG. 9, (138)).

FIG. 7 is a partial cut-away view illustrating the interior of an example implementation and shows a cylindical light display support (120) with attached LED strips (123) disposed longitudinally within cavity (106) of the opaque tube (102). In the example shown, light pipe (112) construction is provided by acrylic rod segments placed in machined apertures (108).

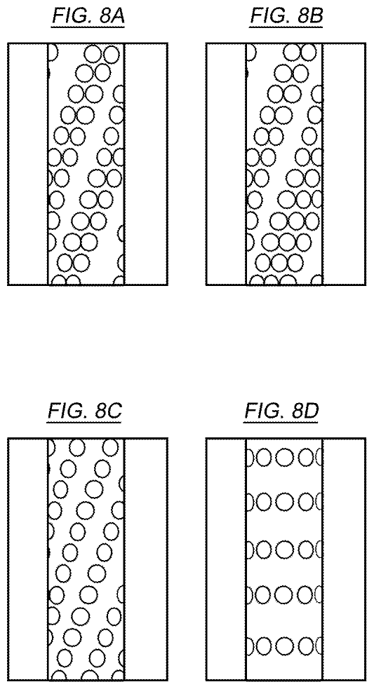

FIGS. 8A-8D illustrate non-limiting examples of possible light pipe (122) patterns.

FIG. 9 shows a partial side elevation of an example implementation including a generally spherical topper (138) that may house one or more light emitting components; e.g., lasers, LEDs, strobe flasher. In some cases the topper may rotate independently of the lower section of the dance pole. In such case, a small motor may rotate the topper at a programmed speed, or the topper rotational speed may be derived from the rhythm and tempo of a music selection.

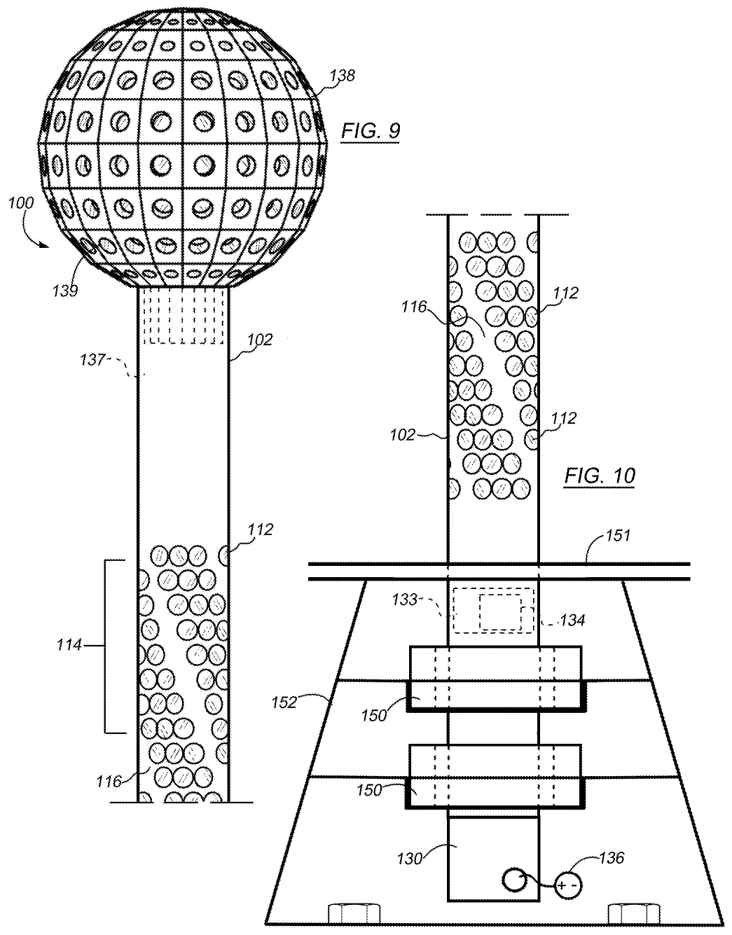

FIG. 10 shows a partial side elevation of an example anchoring assembly suitable for some rotatable implementations. In the example shown, tube (102) is secured and stabilized by mounting platform (151) and thrust bearings (150). At the lower end of the tube is a slip ring (130) providing electrical continuity between the light display components inside the tube and powering components external to the pole. Light display controller(s) (133) and wireless modules (134); e.g., Bluetooth or Wifi, preferably reside inside the rotatable portions of the pole while the DC power supply and transformer may reside proximal to the pole.

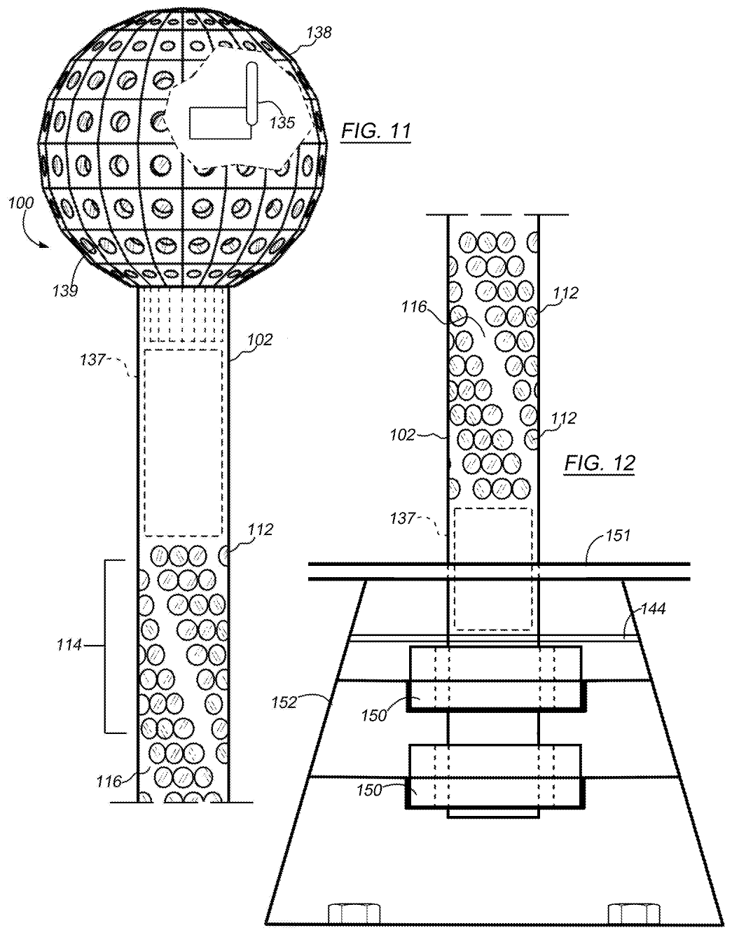

FIG. 11 is another partial side elevation of an example implementation including a topper (138). Topper (138) may house a fan, a heat pipe or heat sink, wireless communications components; e.g., Bluetooth chipset, WiFi antenna (135), WiFi chipset or other electronic components as would be appreciated by those having skill in the art and benefit of this disclosure.

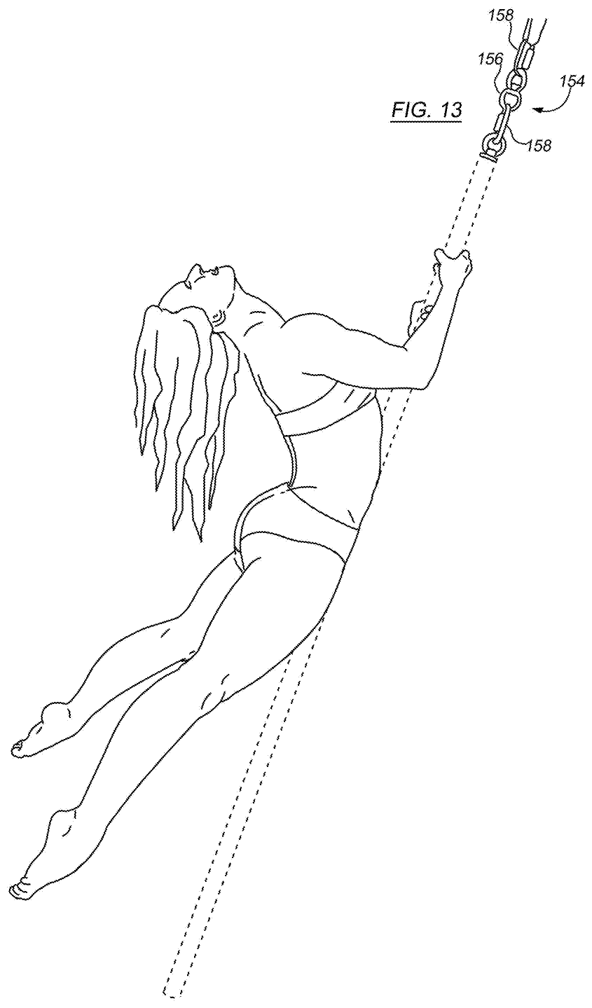

FIG. 12 is another partial side elevation of an example anchoring assembly suitable for some implementations employing a battery (137) as a power source. In some cases, one or more batteries (137) may be disposed within the pole. In some implementations, an inductive charging unit (144) may maintain the batteries in a charged state. Typically, the bottom end of the opaque tube (102) would be coupled to a stabilizing plate (151) and pass through a pair of tapered thrust ball bearing assembles (150)

FIG. 13 illustrates example components for suspending the pole in aerial applications. Typically, a suspension assembly includes one or more swivel couplings (156) linked by one more more carabiners (158).

It should be understood that the drawings and detailed description herein are to be regarded in an illustrative rather than a restrictive manner, and are not intended to be limiting to the particular implementations, forms and examples disclosed. For example, although the implementations illustrated show a dance pole with lighted display, the pole with lighted display may be configured as a hand rail with directional cues. Accordingly, it is intended that this disclosure encompass any further modifications, changes, rearrangements, substitutions, alternatives, design choices, and implementations as would be appreciated by those of ordinary skill in the art having benefit of this disclosure, and falling within the spirit and scope of the following claims.

What is claimed is:

1. A dance pole apparatus comprising:
a cylindrical member with a bottom end, a top end and a side wall, the cylindrical member includes at least one internal cavity and a circumferential arrangement of light pipes that extend from the at least one internal cavity through the side wall, and light emitting ends of the light pipes are disposed flush with a smooth opaque gapless outer surface of the cylindrical member;
a programmable light display member with a plurality of light emitting elements configured to fit inside the at least one internal cavity.

2. The dance pole apparatus according to claim 1 wherein the arrangement of light pipes include plural translucent members.

3. The cylindrical member according to claim one further comprising a wall thickness with range between 3 mm and 13 mm.

4. The cylindrical member according to claim one further comprising a diameter with a range between 38 mm and 78 mm.

5. The dance pole apparatus according to claim 1 wherein the cylindrical member is a metal or ceramic with a minimum tensile strength of 300 Mpa

6. The programmable light display member according to claim 1 further comprising a controller operable via WiFi, and configured to control the light display.

7. The programmable light display member according to claim 1 further comprising wired or inductive power transmission.

8. The programmable light display member according to claim 1 further comprising LEDs.

9. The programmable light display member according to claim 1 further comprising a remote programmable interface.

10. The programmable light display member according to claim 1 further comprising fiberoptic elements.

11. The dance pole apparatus according to claim 1 wherein the cylindrical member is rotatable.

12. The dance pole apparatus according to claim 1 wherein the cylindrical member is is suspendable.

13. The dance pole apparatus according to claim 1 further comprising inductive powering or charging means.

14. The dance pole apparatus according to claim 1 further comprising a topper with a light display.

15. The dance pole apparatus according to claim 1 further comprising a battery.

16. The dance pole apparatus according to claim 1 further comprising an anodized finish on the smooth gapless outer surface.

17. The dance pole apparatus according to claim 1 further comprising a super black coating.

18. The dance pole apparatus according to claim 1 further comprising a filler material disposed in the at least one cavity and surrounding the light display member.

19. The dance pole apparatus according to claim 1 further comprising a wireless communications antenna at the top end.

20. The dance pole apparatus according to claim 1 wherein the cylindrical member includes a heat sink for dissipation of heat generated by the lighting display.
